(19) United States
(12) Patent Application Publication
(10) Pub. No.: US 2009/0268688 A1
(43) Pub. Date: Oct. 29, 2009

(54) ACTIVE SET THRESHOLD ADJUSTMENT METHOD FOR USE IN WIRELESS INTERNET SYSTEM

(75) Inventors: Seung-Que LEE, Daejeon (KR); Nam Hoon Park, Daejeon (KR); Dae Sik Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/477,224

(22) Filed: Jun. 3, 2009

Related U.S. Application Data
(63) Continuation of application No. PCT/KR2007/005996, filed on Nov. 26, 2007.

(30) Foreign Application Priority Data
Dec. 7, 2006 (KR) 10-2006-0124042

(51) Int. Cl. H04W 36/00

(52) U.S. Cl. 370/331

(57) ABSTRACT

Provided is an active set threshold adjustment method for use in a wireless Internet system. The method includes: calculating a resource utilization RU of a base station; calculating an average resource utilization RU_{average} of base stations neighboring the base station; comparing the resource utilization RU to the average resource utilization RU_{average}; and adjusting an active set threshold of the base station based on a comparison result of the resource utilization RU to the average resource utilization RU_{average}.

### RELATED APPLICATIONS

This application is a Continuation Application of PCT International Application No. PCT/KR2007/005996 filed on Nov. 26, 2007, which designated the United States and claims priority to, and the benefit of, Korean Patent Application No. 10-2006-0124042 filed Dec. 7, 2006. The content of the above application is incorporated by reference.

### FIELD OF THE INVENTION

The present invention relates to a wireless Internet system; and, more particularly, to an active set threshold adjustment method based on resource utilization for use in a wireless Internet system using an active set.

### BACKGROUND OF THE INVENTION

As well known in the art, a wireless Internet service in a cellular system is provided using a plurality of base stations (BS), and, thus, a handover procedure to transfer a connection control from a base station to another needs to be performed during a movement of a mobile station (MS).

In order to perform the handover procedure efficiently, a mobile station in a wireless Internet system manages an active set. To be specific, the mobile station adds to the active set one or more candidate base stations which can make communications with the mobile station while moving in addition to a base station currently providing a service thereto, and then manages the active set. The base stations added in the active set perform a pre-handover procedure, i.e., the base stations share therebetween MAC (Media Access Control) contexts relating to the mobile station and make a resource reservation for the mobile station.

Once the pre-handover procedure has been performed, the base stations in the active set can share the MAC contexts, which are information on the mobile station, thereby reducing time required to make a registration of the mobile station to a new base station. Further, resources in the new base station can be reserved for the mobile station, thereby preventing deterioration in quality of service or a termination of service due to a lack of the resources.

Each mobile station in the wireless Internet system manages the active set by adding or deleting a base station to or from the active set depending on signal strength from the base station. To be specific, the base station broadcasts on a broadcast massage thresholds H_Add and H_Delete, and then the mobile station compares the thresholds H_Add and H_Delete to a moving average of the CINR (Carrier to Interference and Noise Ratio) of the base station. As a result of the comparison, if the moving average of the CINR is greater then the threshold H_Add, the mobile station adds the base station to the active set. On the contrary, if the moving average of the CINR is smaller then the threshold H_Delete, the mobile station deletes the base station from the active set.

In conventional handover methods, a mobile station determines a handover target base station based on pilot signal strength received from base stations and quality of service to be provided by each of the base stations, thus balancing traffic load of each of the base stations. Or, stationary users are detected by using mobility of mobile stations, and then different resource reservation or handover policies are applied to the stationary users, thereby increasing system efficiency.

In the wireless Internet system, the active set is a list of base stations with which a mobile station at a given location can communicate. Therefore, the active set closely relates to the thresholds H_Add and H_Delete broadcasted by the base stations. However, the conventional handover methods do not propose a method for adding or deleting the base station to or from the active set by adjusting the thresholds H_Add and H_Delete to be broadcasted by a base station based on whether the base station can reserve resources for a mobile station.

### SUMMARY OF THE INVENTION

In view of the above, the present invention provides an active set threshold adjustment method, for use in a wireless Internet system, for adding or deleting a base station to or from an active set based on resource utilization of a base station to make a resource reservation efficiently.

In accordance with an embodiment of the present invention, there is provided an active set threshold adjustment method for use in a wireless Internet system, the method including:

calculating a resource utilization RU of a base station;

calculating an average resource utilization RU_{average} of base stations neighboring the base station;

comparing the resource utilization RU to the average resource utilization RU_{average}; and

adjusting an active set threshold of the base station based on a comparison result of the resource utilization RU to the average resource utilization RU_{average}.

In accordance with the embodiment of the present invention, the base station compares the resource utilization thereof to the average resource utilization of the neighboring base stations. The base station adjusts the threshold for use in determining the active set based on the comparison result, and then, broadcasts the adjusted threshold to the mobile stations in the cell. Each of the mobile stations adds or deletes the base station to or from the active set using the threshold, and then the base stations perform a resource reservation for the mobile stations. By adjusting the threshold based on the resource utilization of the base station, the resource reservation can be performed efficiently.

Further, the number of mobile stations capable of requesting the resource reservation to the base station is controlled by adjusting the threshold based on the resource utilization of the base station, thus preventing the base station from reserving excessively large number of resources.

### BRIEF DESCRIPTION OF THE DRAWINGS

The objects and features of the present invention will become apparent from the following description of an embodiment, given in conjunction with the accompanying drawings, in which:

FIG. 1 illustrates a relationship between an active set threshold and a cell radius of a base station in a wireless Internet system in accordance with an embodiment of the present invention; and

FIG. 2 illustrates a flow chart of an active set threshold adjustment method for use in the wireless Internet system in accordance with the embodiment of the present invention.

### DETAILED DESCRIPTION OF THE EMBODIMENT

Hereinafter, an embodiment of the present invention will be described in detail with reference to the accompanying drawings.

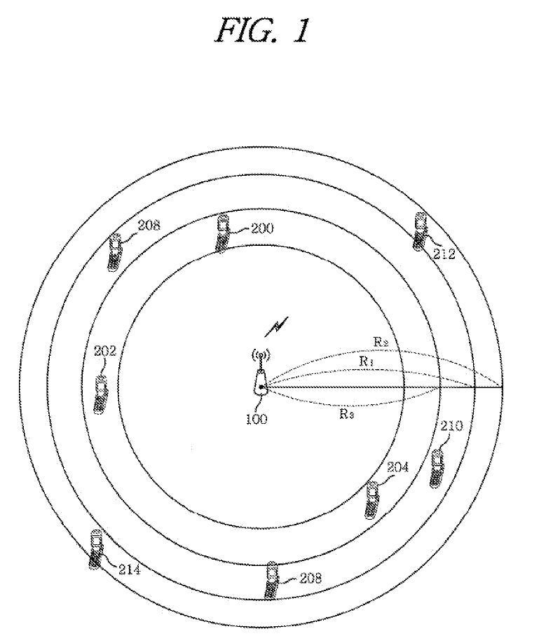

FIG. 1 illustrates a relationship between an active set threshold and a cell radius of a base station 100 in a wireless Internet system in accordance with an embodiment of the present invention.

Referring to FIG. 1, reference symbol R1 denotes a cell radius of the base station 100 when a threshold H_Add is used in determining an active set of respective mobile stations 200 to 214; reference symbol R2 denotes the cell radius when the threshold H_Add is decreased by a positive number α; and reference symbol R3 denotes the cell radius when the threshold H_Add is increased by the positive number α. The above-described variation in the cell radius is due to the fact that signal strength received by the mobile stations 200 to 214 from the base station 100 decreases in proportion to the distance therebetween. As shown in FIG. 1, a cell coverage area of the base station 100 depends on the threshold H_Add.

For example, when the threshold H_Add is used, the base station 100 can be added to the active sets of the mobile stations 200 to 210. When the threshold H_Add is increased by α, the base station 100 can be added to the active sets of the mobile stations 200 to 204 only. When the threshold H_Add is decreased by α, the base station 100 can be added to the active sets of the mobile stations 212 and 214 as well as those of the mobile stations 200 to 210. That is, the number of mobile stations which can add a base station to active sets thereof depends on the threshold H_Add.

Further, there exists another threshold H_Delete broadcasted by the base station 100. The threshold H_Delete is used as reference signal strength for deleting the base station 100 from the active sets of the mobile stations 200 to 214. Preferably, the threshold H_Delete is set to be smaller than the threshold H_Add by a specific amount. By setting the thresholds H_Add and H_Delete differently, excessively frequent change in the active sets due to additions or deletions of the base station 100 can be prevented. Moreover, it is preferable that the threshold H_Delete is increased or decreased by the same amount as the threshold H_Add varies. The difference between the thresholds H_ADD and H_Delete can be given as system parameters of the wireless Internet system, and also, does not affect the resource reservation method of the present invention.

A method for adjusting an active set threshold of a base station based on a resource utilization of the base station and an average resource utilization of neighboring base stations will be described below.

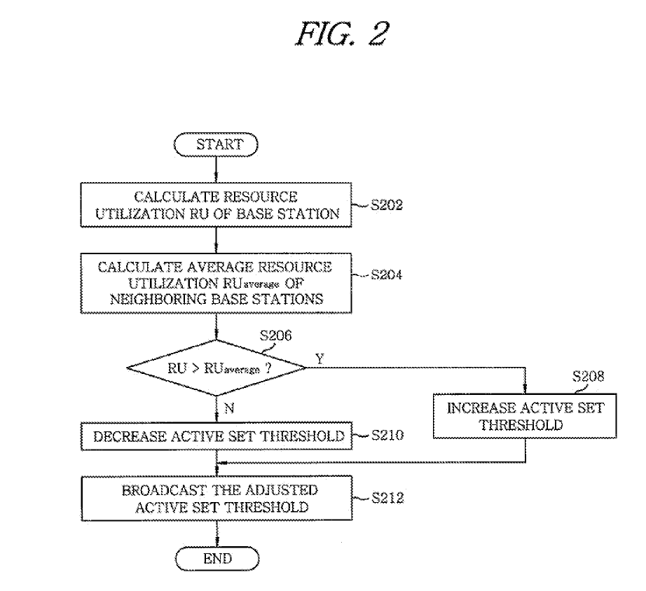

FIG. 2 illustrates a flow chart of an active set threshold adjustment method for use in the wireless Internet system in accordance with the embodiment of the present invention.

Referring to FIG. 2, each base station in the wireless Internet system calculates a resource utilization RU thereof (step S202). The resource utilization RU is calculated according to Equation 1.

$$R U = \frac{{C}_{allocated}}{{C}_{total}} \qquad Equation 1$$

In Equation 1, Cₜₒₜₐₗ represents the total number of channels in a base station and C_{allocated} represents the number of channels currently allocated to mobile stations within a cell coverage area of the base station. The resource utilization RU has a value in a range from 0 to 1, and, the greater the value is, the higher the resource utilization RU is.

The base station receives resource utilizations RU from neighboring base stations, and then calculates an average resource utilization RU_{average} of the neighboring base stations (step S204). Here, the base station may periodically receive the resource utilizations RU from the neighboring base stations via a wired back-bone network.

The base station compares the resource utilization RU thereof to the average resource utilization RU_{average} derived from the neighboring base stations. From the comparison result, it is determined whether the resource utilization RU is greater than the average resource utilization RU_{average} (step S206).

If it is determined in the step S206 that the resource utilization RU is greater than the average resource utilization RU_{average}, which means that the base station has less extra resources relative to the neighboring base stations, the base station increases the threshold H_Add by a specific amount (step S208) to reduce resource reservation requests from mobile stations to the base station. Here, the specific amount is a step value to increase or decrease the threshold H_Add, and may be set as a system parameter.

If it is determined in the step S206 that the resource utilization RU is smaller than the average resource utilization RU_{average}, which means that the base station has more extra resources relative to the neighboring base stations, the base station decreases the threshold H_Add by the specific amount (step S210) to increase the resource reservation requests from the mobile stations to the base station. In the steps S208 and S210, the threshold H_Add is increased or decreased to be in a range from a minimum threshold value H_Addₘᵢₙ to a maximum threshold value H_Addₘₐₓ which may be set as system parameters.

The base station broadcasts to the mobile stations the threshold H_Add adjusted in the step S208 or S210 on the DCD (Downlink Channel Descriptor) message (step S212). After that, each mobile station adds or deletes the base station to or from the active set thereof using the threshold H_Add, and the resource reservation is performed in the base stations. To be specific, the mobile station adds the base station to the active set when the signal strength from the base station is stronger than the threshold H_Add. Meanwhile, the mobile station deletes the base station from the active set when the signal strength from the base station is weaker than the threshold H_Add.

Therefore, the resource reservation in the wireless Internet system can be made efficiently by adjusting the threshold H_Add based on the comparison result of the resource utilization RU of the base station to the average resource utilization RU_{average} of the neighboring base stations.

While the invention has been shown and described with respect to the embodiment, it will be understood by those skilled in the art that various changes and modification may be made without departing from the scope of the invention as defined in the following claims.

What is claimed is:

1. An active set threshold adjustment method for use in a wireless Internet system, the method comprising:
calculating a resource utilization RU of a base station;
calculating an average resource utilization RU_{average} of base stations neighboring the base station;
comparing the resource utilization RU to the average resource utilization RU_{average}; and
adjusting an active set threshold of the base station based on a comparison result of the resource utilization RU to the average resource utilization RU_{average}.

2. The method of claim 1, wherein the resource utilization RU is calculated by the following equation:
$$R U = \frac{{C}_{allocated}}{{C}_{total}}$$
wherein, Cₜₒₜₐₗ represents the total number of channels in the base station and C_{allocated} represents the number of channels currently allocated to mobile stations within a cell coverage area of the base station.

3. The method of claim 1, wherein the resource utilization RU has a value in a range from 0 to 1, and the greater the value is, the higher the resource utilization RU is.

4. The method of claim 2, wherein the resource utilization RU has a value in a range from 0 to 1, and the greater the value is, the higher the resource utilization RU is.

5. The method of claim 1, wherein the active set threshold is increased by a specific amount if the resource utilization RU is greater than the average resource utilization RU_{average}, or decreased by the specific amount if the resource utilization RU is greater than the average resource utilization RU_{average}.

6. The method of claim 5, wherein the specific amount is a step value to increase or decrease the active set threshold, and set as a system parameter.
